(19) United States
(12) Patent Application Publication
(10) Pub. No.: US 2002/0079777 A1
(43) Pub. Date: Jun. 27, 2002

(54) Peripheral interlocks for stator cores

(76) Inventor: Robert D. Sirois, Fort wayne, IN (US)

Correspondence Address: Armstrong Teasdale LLP, Suite 2600, One Metropolitan Sq., St. Louis, MO, 63102, US

(21) Appl. No.: 09/748,583

(22) Filed: Dec. 22, 2000

(51) Int. Cl. H02K 1/00; H02K 1/12

(52) U.S. Cl. 310/216; 310/254

(57) ABSTRACT

A method for manufacturing a laminated stator core for an electric motor includes providing a plurality of generally planar laminations, forming a plurality of notches into the lamination, and finally forming a plurality of interlock tabs. The notches extend outward from the interlock tabs to an outside diameter of the lamination to create a void in the back iron area of the interlock tabs to reduce the flux leakage.

### BACKGROUND OF THE INVENTION

This invention relates generally to electric motors and more particularly to stator core interlocks that allow minimal flux leakage.

Electric motors can vary from small, fractional motors that are found, for example, in washing machines, refrigerators and air conditioners, to large industrial motors that are found, for example, in manufacturing equipment, compressors, fans and the like. A typical motor includes a rotating central portion known as a rotor and a stationary outer portion referred to as a stator. Both the stator and rotor are contained, at least partially within a housing that carries the motor. A stator core is typically formed from a plurality of stacked plates or laminations. The laminations which are generally formed from metal, may be punched or pressed and subsequently stacked one on top of another to form the stator core. Due to the possible asymmetries in the lamination material, the laminations can be rotated so that the stator core, upon final assembly, forms a straight rather than lopsided stack. The laminations are interlocked with one another to form a rigid stator core structure and to prevent the laminations from shifting relative to one another.

In one known interlocking arrangement, each lamination has a dimple or a recess punched into the surface which forms a corresponding projection on the opposite side of the lamination. The laminations are then stacked one on top of the other with the projections from one lamination engaging and residing within the recess in the next adjacent lamination. In this nested arrangement, the laminations are aligned with one another by engagement of the projections and recesses. This is a common and accepted method for interlocking laminations. However, the common and accepted method does not reduce the flux leakage.

Therefore, it would be desirable to provide a method for a stator core interlocking arrangement that is cost effective as well as effective in reducing the flux leakage.

### BRIEF SUMMARY OF THE INVENTION

In one embodiment, a stator lamination includes a plurality of notches and interlock tabs. The notches extend outward from the interlock tabs to an outer diameter of the lamination to create a void in a back iron area of the interlock tabs. The laminations are stacked to form a stator core. The stack defines at least one inner lamination having laminations positioned adjacent to both sides of the laminations. Each lamination has notches extending outward from an outside edge of the interlock tabs to the outer diameter of the stator lamination, thus creating a void in the back iron area of the stator lamination adjacent the interlocking tabs. The notch impinges upon the interlock tabs along the length of the stator core, interrupting the flux path through the iron towards the outer diameter of the interlock. Since the flux path is interrupted, the flux is significantly less likely to link the conductive interlocks, and thereby reduces the current flow through the interlocks.

In yet another embodiment, a method for manufacturing a laminated stator core for an electric motor includes forming a plurality of notches and tabs in the interlock laminations. More particularly, the method includes providing a plurality of generally planar laminations, each lamination having an axis substantially perpendicular to the lamination plane, forming a plurality of notches in the lamination, and forming a plurality of interlock tabs. The laminations are stacked to form a stator core.

### BRIEF DESCRIPTION OF THE DRAWINGS

FIG. 1 is an exploded, perspective view of an exemplary motor, illustrating a stator having a core formed in accordance with one embodiment of the present invention;

FIG. 2 is a top view of the stator core shown in FIG. 1;

FIG. 3 is an enlarged view of a notch area shown in FIG. 2;

FIG. 4 is an enlarged view of an alternative embodiment of the notch area shown in FIG. 2;

FIG. 5 is an enlarged view of a further alternative embodiment of the notch area shown in FIG. 2;

FIG. 6 is an enlarged view of a still further embodiment of the notch area shown in FIG. 2; and

FIG. 7 is a side view of the stator core shown in FIG. 1.

### DETAILED DESCRIPTION OF THE INVENTION

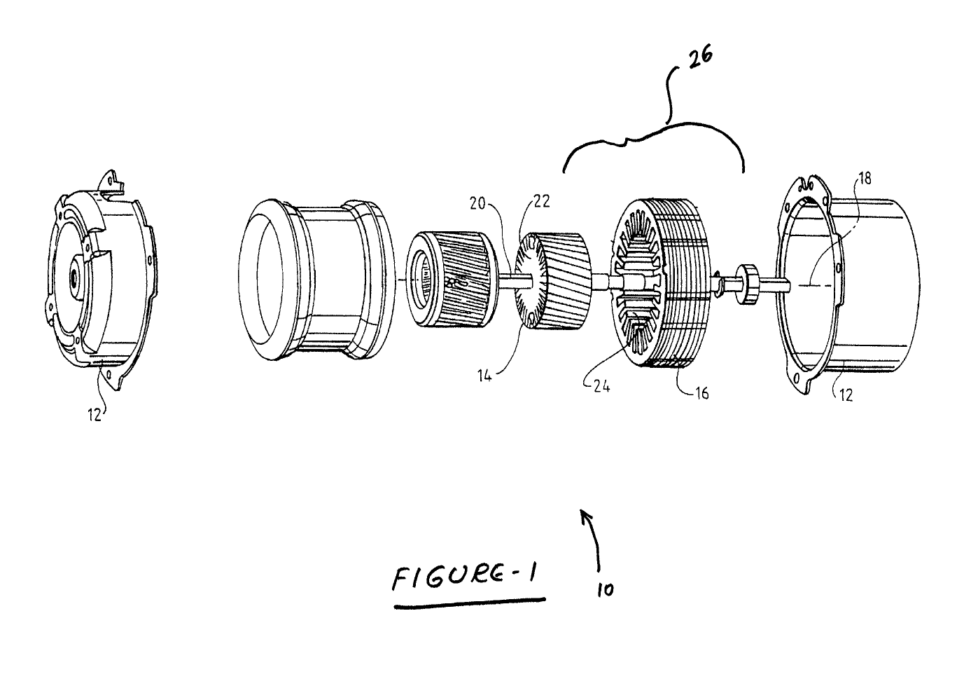

FIG. 1 is an exploded, perspective view of an exemplary motor 10, illustrated in accordance with the principles of the present invention. Motor 10 is enclosed within a housing 12 and includes a rotor 14 and a stator 16. Stator 16 is mounted to and at least partially within housing 12. Stator 16 includes a longitudinal axis 18, there-through. Rotor 14 is positioned at least partially within stator 16 and includes a longitudinal axis 20 collinear with stator axis 18.

Rotor 14 is positioned within stator 16 such that a gap (not shown) extends therebetween. The gap is sufficiently large to permit rotor 14 to freely rotate within stator 16 without contacting stator 16. In addition, the gap is sufficiently small such that a magnetic field which is created in stator 16 can in turn induce an electric current in rotor 14 which generates an opposing magnetic field. Interaction between these two magnetic fields is converted to mechanical energy and results in rotation of rotor 14. As the gap between rotor 14 and stator 16 increases, the rotor current inducement decreases. Thus, the size of the gap between the rotor 14 and stator 16 must be determined by balancing the need to maintain space between rotor 14 and stator 16 while maintaining rotor 14 and stator 16 sufficiently close to reduce and preferably minimize field losses.

Rotor 14 includes a rotor core 22 and stator 16 includes a stator core 24 formed from a plurality of plates or laminations 26 stacked together. Laminations 26 are secured relative to one another by an interlocking system. The interlocking system prevents the laminations 26 from rotating, shifting and separating from each other, and thus maintains stator core 24 as a unitary member during motor fabrication.

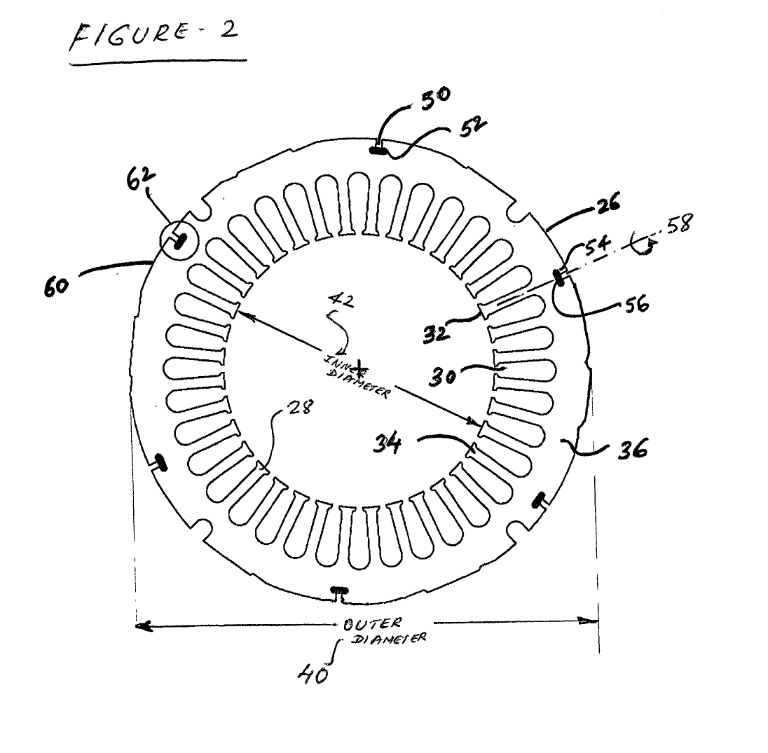

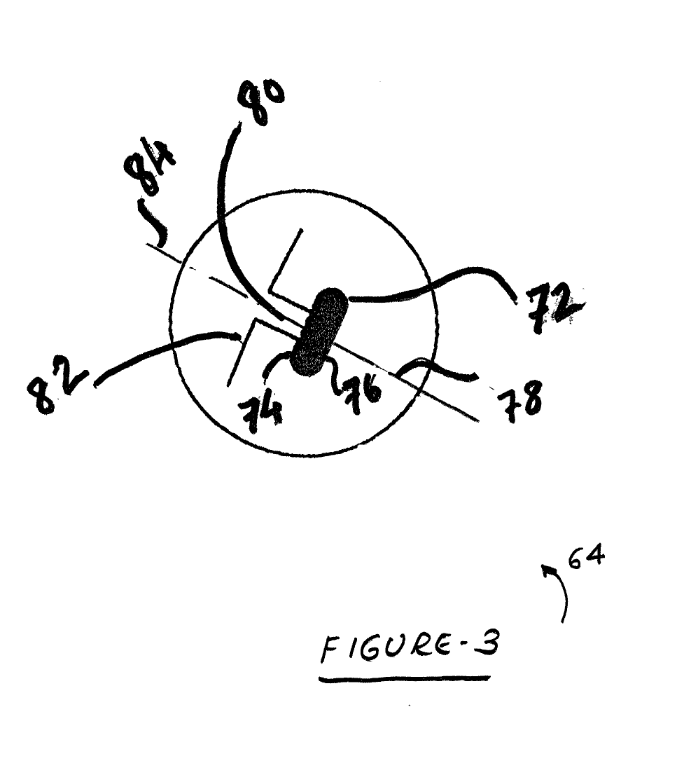

FIG. 2 is a top view of the stator core shown in FIG. 1. Stator core 24 (shown in FIG. 1) includes a plurality of teeth 28 defining a plurality of slots 30. Teeth 28 are formed at an inner edge 32 of each lamination 26. Teeth 28 are formed integral with the lamination outer or ring portion 36. Slots 30 are configured to receive and secure conducting elements (not shown) therein. Stator core lamination 26 defines an outer diameter 40 and an inner diameter 42 of stator core 24. A group of notches or openings 50 are punched into lamination 26 prior to punching a plurality of stator interlock tabs 52. Interlock tabs 52 include an outside edge 54, an inside edge 56, an axis of symmetry 58 and have an oval shape. Notches 50 are oriented such that they extend outward from outside edge 54 of interlock tab 52 to an outside diameter 60 of stator lamination 26. Interlock tabs 52 are partially punched through lamination 26. In the exemplary embodiment, there are six notches 50 and six interlock tabs 52. When stator core 24 is assembled, each interlock tab 52 enhances the engagement between the laminations, to prevent shifting therebetween. FIGS. 3 through 6 (described below) explain the lamination interlocking arrangement in detail.

FIG. 3 is an enlarged view of a notch area 62 (shown in FIG. 2). A stator lamination 64 includes an interlock tab 72. Interlock tab 72 has an outside edge 74, an inside edge 76 and an axis of symmetry 78. A notch 80 extends outward from outside edge 74 of interlock tab 72 to an outside diameter 82 (also numbered as 60 in FIG. 2) of stator lamination 26 shown in FIG. 2. Notch 80 is fully punched through lamination 26. Interlock tab 72 is partially punched through lamination 26. Notch 80 has an axis of symmetry 84 that substantially coincides with axis of symmetry 78 of tab 72. There are six notches 80 and six partially punched interlock tabs 72.

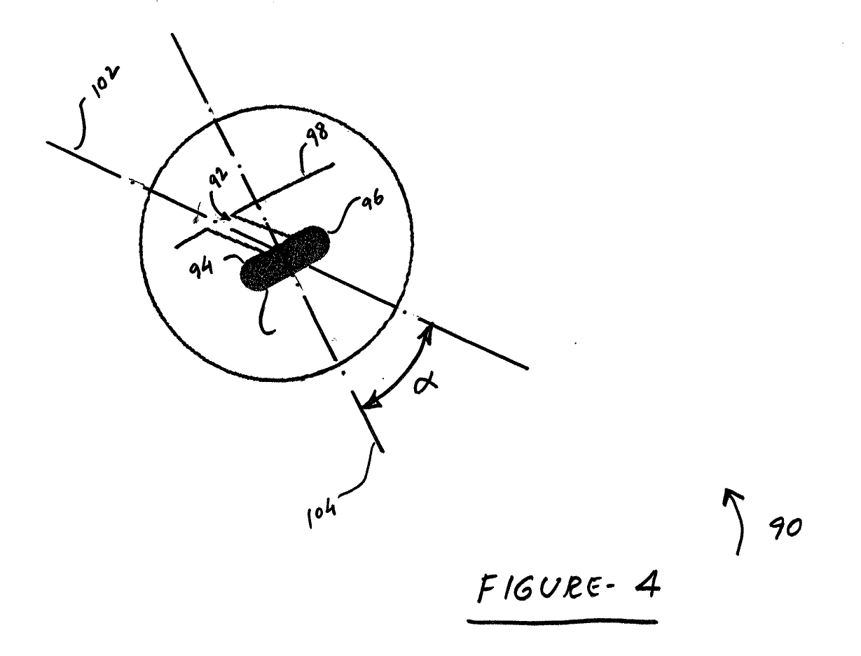

FIG. 4 is an enlarged view of an alternative embodiment of notch area 62 (shown in FIG. 2). A stator lamination 90 includes a notch 92 punched at an angle α. Notch 92 extends outward from an outside edge 94 of interlock tab 96, at angle α, to an outside diameter 98 of stator lamination 90. An inside edge 100 of interlock tab 96 is substantially parallel to outside edge 94. An axis of symmetry 102 of interlock tab 92 does not coincide with an axis of symmetry 104 of notch 92. Instead, axis of symmetry 102 is positioned at angle α with respect to axis of symmetry 104.

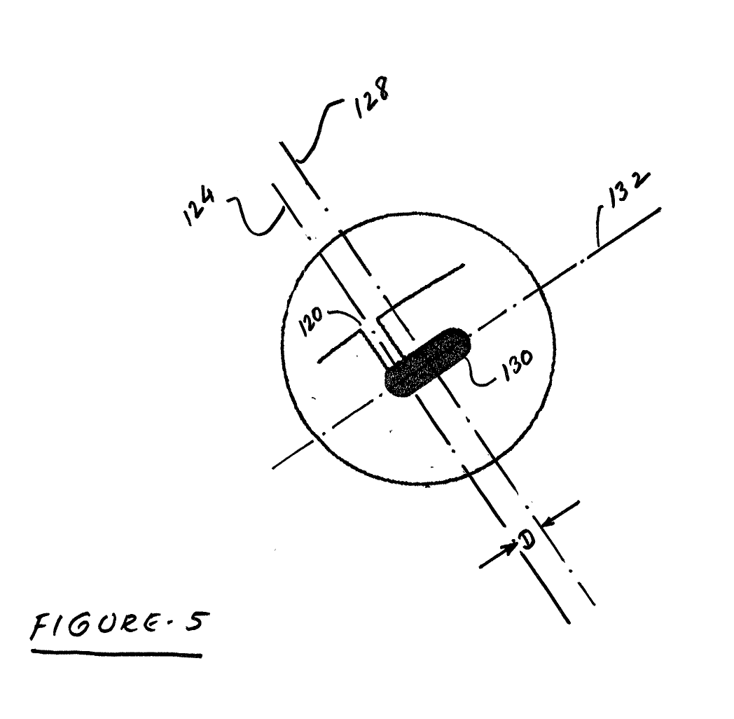

FIG. 5 is an enlarged view of a further alternative embodiment of notch area 62 (shown in FIG. 2). A stator lamination 110 includes a notch 120. An axis of symmetry 124 of notch 120 is substantially parallel to an axis of symmetry 128 of an interlock tab 130. Notch 120 is punched at a perpendicular angle to an axis of symmetry 132 of interlock tab 130. Axis of symmetry 132 is perpendicular to both axes 124 and 128. Furthermore, axis of symmetry 124 does not coincide with axis of symmetry 128. Instead axis of symmetry 124 is located a pre-determined distance “D” from axis of symmetry 128. The stator lamination arrangement in this embodiment provides substantial surface area of interlock tabs for more robust mechanical engagement than other embodiments.

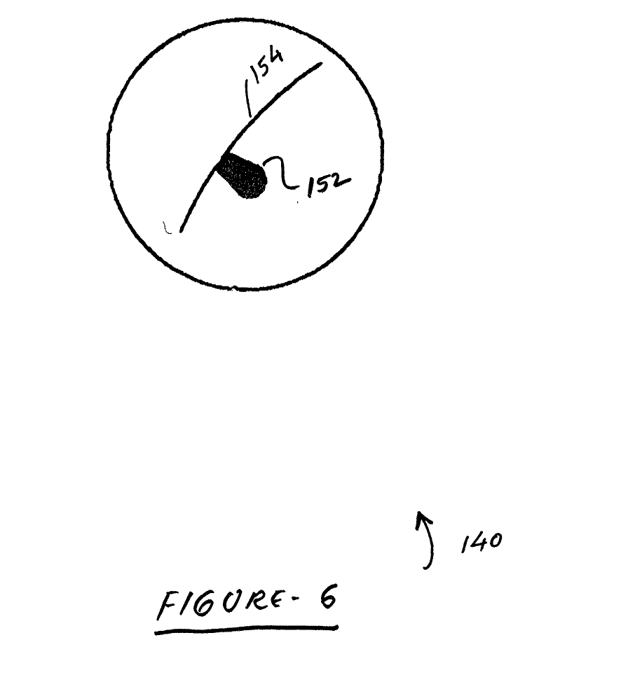

FIG. 6 is an enlarged view of a still further embodiment of notch area 62 (shown in FIG. 2). A stator lamination 140 includes a partially punched interlock tab 152. Notch 50 (shown in FIG. 2) is not punched. Additionally, interlock tab 152 extends inward from an outside diameter 154 of stator lamination 140.

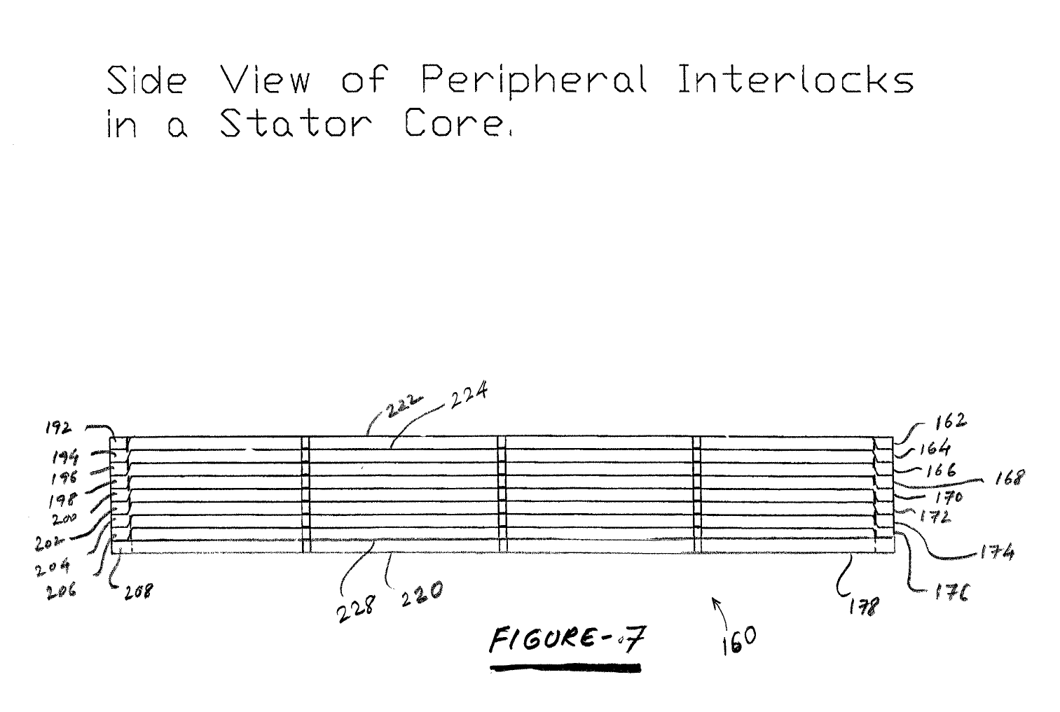

FIG. 7 is a side view 160 of stator core 24 shown in FIG. 1. Each lamination of stator core 24 includes at least two interlock tabs. Interlock tabs are stacked on top of each other to lock adjacent laminations together. For example, a lamination 162 has a corresponding interlock tab 192. Similarly laminations 164, 166, 168, 170, 172, 174, and 176 have corresponding interlock tabs 194, 196, 198, 200, 202, 204, and 206 respectively. For example, one end lamination 178 receives interlock tab 206 (also shown as number 52 in FIG. 2) of adjacent lamination 176. Similarly, interlock tab 192 of lamination 162 is received by adjacent lamination 164. Since lamination 178 is the end lamination of stator core 24, lamination 178 does not include a punched tab, but instead has a flat surface 220. Thus, lamination 178 receives interlock tabs 206 of adjacent lamination 176.

In the exemplary embodiment, there are at least two interlock tabs per lamination. Interlock tab 192 of lamination 162 is received by lamination 164. Interlock tab 194 of lamination 164 is received by lamination 166. The upper surface 222 (shown as 36 in FIG. 2) of lamination 162 (shown as 26 in FIG. 2) is substantially flat and substantially parallel to a second surface 224 of lamination 162. End lamination 178 has a flat surface 220 and an upper surface 228, both surfaces substantially parallel. End lamination 178 receives interlock tabs 206 of adjacent lamination 176. There are no interlock tabs on end lamination 178.

End laminations 162 and 178 are formed such that they are engaged by only one adjacent lamination 164 and 176 respectively. On the other side, interior laminations 164, 166, 168, 170, 172, and 174 engage two adjacent laminations, one at the top and other at the bottom.

The embodiments described above relate specifically to stator lamination arrangements in detail. However, the lamination arrangements are equally applicable to rotor lamination, interlock transformer lamination, ballast lamination, automobile and other ignition coils and various other commercially available electrical devices that utilize lamination arrangements.

While the invention has been described in terms of various specific embodiments, those skilled in the art will recognize that the invention can be practiced with modification within the spirit and scope of the claims.

What is claimed is:

1. A method for manufacturing a laminated stator core for an electric motor, said method comprising the steps of:
providing a plurality of generally planar laminas, each lamina having an axis substantially perpendicular to the lamina plane;
forming a plurality of notches in the lamina; and
forming a plurality of interlock tabs, the notches extending outward from the interlock tabs to an outside diameter of the laminas.

2. The method according to claim 1 wherein the plurality of interlock tabs have an oblong shape.

3. The method according to claim 2 wherein the interlock tabs have an inside edge, an outside edge, and a pair of substantially semi-circular edges.

4. The method according to claim 1 wherein each lamina includes at least two interlock tabs.

5. The method according to claim 1 wherein said method further comprising the steps of:
stacking each lamina on top of an adjacent lamina to form a stack of laminas; and
stacking a first lamina, a plurality of interior laminas, and a last lamina such that the interlock tabs of the first lamina and the interior laminas engage an adjacent lamina to prevent shifting therebetween.

6. The method according to claim 5 wherein the first and the last lamina include an upper surface and a lower surface, the upper surface substantially parallel to the lower surface, the first lamina's upper surface and the last lamina's lower surface substantially parallel to each other and substantially flat.

7. A method for manufacturing a laminated stator core for an electric motor, said method comprising the steps of:
providing a plurality of generally planar laminas, each lamina having an axis substantially perpendicular to the lamina plane; and
forming a plurality of interlock tabs, wherein the interlock tabs extend to an outside diameter of the laminas.

8. An electric motor comprising:
a housing;
a stator comprising a stator core, said stator at least partially within said housing, said stator core comprising a plurality of generally planar laminas, each lamina having an axis, each said lamina comprising a plurality of notches and a plurality of interlock tabs, the notches extending outward from the interlock tabs to an outside diameter of said laminas; and
a rotor having a rotor core and disposed at least partially within said stator.

9. The electric motor according to claim 8 wherein said rotor is disposed coaxially within said stator.

10. The electric motor according to claim 8 wherein said interlock tabs have an oblong shape, an inside edge, an outside edge, and a pair of semi-circular edges.

11. The electric motor according to claim 8 wherein said each said lamina includes at least two interlocking tabs.

12. The electric motor according to claim 8 wherein each said lamina of said stator core stacked on top of an adjacent lamina to form a stack of laminas, said stack of lamina further comprising a first lamina, a plurality of interior laminas, and a last lamina, said plurality of interior laminas arranged in-between said first and said last lamina, said each lamina having at least a plurality of interlock tabs, said plurality of interlock tabs received by each adjacent lamina to enhance the engagement between said laminas.

13. The electric motor according to claim 12 wherein said first lamina and said last lamina further comprising an upper surface and a lower surface, said upper surface substantially parallel to said lower surface, said first lamina's upper surface and said last lamina's lower surface substantially parallel to each other and substantially flat.

14. An electric motor comprising:
a housing;
a stator comprising a stator core, said stator at least partially within said housing, said stator core comprising a plurality of generally planar laminas, each lamina having an axis, each said lamina comprising a plurality of interlock tabs, the plurality of interlock tabs extending outward to an outside diameter of said laminas; and
a rotor having a rotor core and disposed at least partially within said stator.

15. A stator core comprising
a plurality of generally planar laminas, each said lamina having a plurality of notches with a first axis of symmetry and a plurality of interlock tabs with a second axis of symmetry, the notches extending from the interlock tabs to an outside diameter of said laminas.

16. The stator core according to claim 15 wherein said first axis of symmetry and said second axis of symmetry of coincide.

17. The stator core according to claim 15 wherein said first axis of symmetry and said second axis of symmetry do not coincide.

18. The stator core according to claim 15 wherein said first axis of symmetry is positioned at an angle α with respect to said second axis of symmetry.

19. The stator core according to claim 15 wherein said interlock tabs have oblong shape, an inside edge, an outside edge, and a pair of semi-circular edges.

20. The stator core according to claim 15 wherein the interlock tabs includes a third axis of symmetry, said third axis of symmetry perpendicular to said first and said second axis of symmetry, said first axis of symmetry further located a pre-determined distance from said second axis of symmetry.

21. A stator core comprising a plurality of generally planar laminas, each said lamina having a plurality of interlock tabs with an axis of symmetry, the interlock tabs extending to an outside diameter of said laminas.
